(19) United States
(12) Patent Application Publication
(10) Pub. No.: US 2010/0171315 A1
(43) Pub. Date: Jul. 8, 2010

(54) WIND ENERGY CAPTURE DEVICE

(76) Inventor: Kerry Flood, Santa Maria, CA (US)

Correspondence Address: MICHAEL A. SHIPPEY, PH. D., J.D., 1111 E. Commonwealth Avenue, Suite B, Fullerton, CA, 92831, US

(21) Appl. No.: 12/350,878

(22) Filed: Jan. 8, 2009

(51) Int. Cl. F03D 9/00

(52) U.S. Cl. 290/55

(57) ABSTRACT

A device to collect wind energy from the rooftop of a house or other building is described. The device encompasses a wind scoop, which can be moved in any direction to ‘catch’ the prevalent wind. The wind passes through conduits to a low-profile wind turbine, which is configured for maximum containment of wind and energy capture. The turbine powers a electricity generator to produce electricity. In an alternative embodiment, the turbine can be powered by moving water from ordinary municipal water lines or other sources.

### FIELD OF THE INVENTION

The present invention relates to the field of wind energy capture devices, and more particularly to a device for harnessing wind energy from rooftops in areas where present technology is unsuitable. This includes but is not limited to inner-city neighborhoods and rural subdivisions where real estate is at a premium and wind turbine towers may be prohibited by or deemed unfeasible due to lack of available space, local ordinances, and/or environmental factors such as excessive wind turbulence near ground surface.

### BACKGROUND

The ongoing search for alternative and renewable energy sources has led many to investigate the harnessing of wind power. Millions of dollars have been invested in large numbers of windmills and wind turbines that are propelled by wind, ultimately converting wind energy into electricity on fairly large scales. These systems are esoterically referred to as big wind technology. Smaller scale wind harnessing devices for use by individuals is referred to as small wind technology. The present use of big wind technology is dominated by environmental factors. Specifically, ambient wind velocity and duration determine the amount of wind power available for electricity production. Thus big wind energy production projects (wind farms) are immediately limited to suitable locations. Present big wind technology is such that the amount of wind power harnessed is directly dependant on the length of wind turbine blades, as this determines the wind swept area captured. In order to harness more power, larger turbines are used. Apart from location, turbulence is considered the single-most problematic factor in wind energy production. Turbulence is predominantly caused by surface friction and impediments such as terrain irregularities, forests and vegetation, and man made structures. To minimize turbulence, big wind technology includes the use of towers high enough to place turbines above the influence of surface friction. These towers are typically 100-300 feet in height. Even so, on wind farms each turbine becomes a change agent by creating turbulence in its own wake stream, which poses problems for additional turbines downwind. Turbulence causes mechanical stress and wear on the most vulnerable and costly components of wind turbine generators. Present small wind technology is largely imitative of big wind technology and is therefore similarly dependant. For most people who might otherwise make use of wind power technology, using a tower high enough to avoid turbulence is unfeasible. Therefore, relatively little attention has been paid to smaller scale wind harnessing devices for use by individuals.

One such device is described in U.S. Pat. No. 7,315,093 B2. This patent issued very recently (Jan. 1, 2008) to inventor J. J. Graham, sr. That patent concerns a vertically mounted rooftop fan, with deflector. U.S. Pat. No. 6,606,823, which issued on Apr. 19, 2003, to inventors W. McDonough et al., depicts a roof covering for cooling a structure with water. No fan is involved in this invention.

Related art is also presented in U.S. Pat. No. 6,838,782, which issued on Jan. 4, 2005 to inventor T. H. Vu. This patent describes a fan and pulley system for moving vehicles, especially trucks. U.S. Pat. No. 6,327,994, which issued to inventor G. Labrador on the fateful day of Sep. 11, 2001. This describes a wide-faced open fan-like device for fluid impelling or solar collection.

Although the above prior art is considered to be relevant to the current invention, no description has been found that anticipates the current invention, nor that renders the current invention obvious.

### SUMMARY OF THE INVENTION

The invention herein described and presented includes a moveable wind-capturing device (wind scoop), a conduit for conveying and directing wind onto a specific part of a turbine rotor, and a turbine rotor which is enclosed to minimize turbulence. It is designed for mounting on building rooftops. The wind scoop can be manually or automatically positioned to face in any horizontal direction so as to always be directed into the wind, for maximum wind energy capture.

It is therefore an object of the present invention to provide an innovative method for the capturing of wind energy in a near surface environment, which necessitates a means of minimizing or eliminating the effect of turbulence on the most vulnerable and expensive components of the device.

It is further an object of the present invention to separate the relationship of wind capture area from the length of wind turbine rotor blades, thus enabling a smaller turbine rotor to be powered by a larger amount of wind than would be possible using present technology.

It is further an object of the present invention to achieve energy savings through endpoint generation of electricity by harnessing and converting wind energy.

It is further an object of the present invention to provide an easily visible display of energy consciousness of the owner, while producing a tasteful and esthetically pleasing article that will not raise objections from neighbors.

It is further an object of the present invention to maximize power available via unique application of natural physical laws.

It is further an object of the present invention to provide a system which is adaptable to a wide variety of locations which would otherwise not be considered using present technology.

It is further an object of the present invention to adapt specific components for additional related uses. This includes but is not limited to the adaptation of the enclosed rotor/turbine to be resized and powered by pressurized water in existing pipelines, such as the main culinary water lines to houses and buildings. This would require adaptation for dual use as an adjustable pressure regulator.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The many objects and advantages of the present invention will become apparent from the following descriptions, taken in connection with the accompanying drawings, wherein, by way of illustration and example, an embodiment of the present invention is disclosed.

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows a device of a preferred embodiment of the current invention from above, mounted on a rooftop. It is herein emphasized that the rotor enclosure may be mounted at any angle, and could be alternatively mounted on a side wall of a building rather than on the rooftop (configuration not shown).

FIG. 2 shows detail of the wind scoop in a preferred embodiment of the current invention, and the turning device, also called a turret, that allows the scoop to move 360 degrees facing any horizontal direction. The duct as shown appears rigid, however in practice it is expected that an airtight flexible tube would be used. Note that the duct is smaller in diameter than the wind capture area. It is expected this would increase velocity of the wind, which is known to be an exponential factor in wind power generation. As a result, this configuration could produce greater power than a present technology open-air turbine with a diameter and subsequent wind capture area similar to the area of the wind scoop in this submitted design.

FIG. 3 shows detail of the rotor and enclosure box in an expanded view of portions the current invention. It should be noted that a generator can be mounted either on the top or bottom of the enclosure (enclosure top cover not shown).

FIG. 4 displays further details of individual rotor components. While each component may be constructed using lightweight, thin and otherwise flexible materials, when assembled they creates a structurally rigid rotor. It should be noted that the rotor blades could be more efficient using a different geometry, such as a curved blade rather than an angled blade. The curved blade (not shown) would be similar in shape to a pipe split in half lengthwise. Such refinements are pending working model construction and testing.

FIG. 5a displays the rotor in a position perpendicular to the channeled wind stream. This illustration demonstrates the utility of the blade fence (see FIG. 4) in guiding air movement along the desired path.

FIG. 5b displays the rotor turned approximately 30 degrees clockwise. This is intended to illustrate the progression of wind through the outlet, which allows expansion of the wind stream. This configuration is expected to result in lower pressure on the backside of the rotor blade and higher pressure on the front side of the rotor blade at all positions of the rotor.

### DETAILED DESCRIPTION OF THE INVENTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

The present invention comprises a moveable wind energy-capturing device. It is designed for mounting on a rooftop. The device can be manually or automatically positioned to face in any direction, so as to always be directed into the wind, for maximum wind energy effect.

A preferred embodiment of the current invention comprises a large air scoop; a turret or other means for positioning the scoop into the wind; and a turbine, within a housing, which is moved by the wind. The turbine powers a standard electrical generator, which produces electricity for local usage.

Preferably the turbine rotor is contained in an enclosure (rotor box). The blades of the turbine are especially designed to capture as much of the wind energy as possible, while minimizing the leakage of air around the blades. The housing aids in this capture of wind energy.

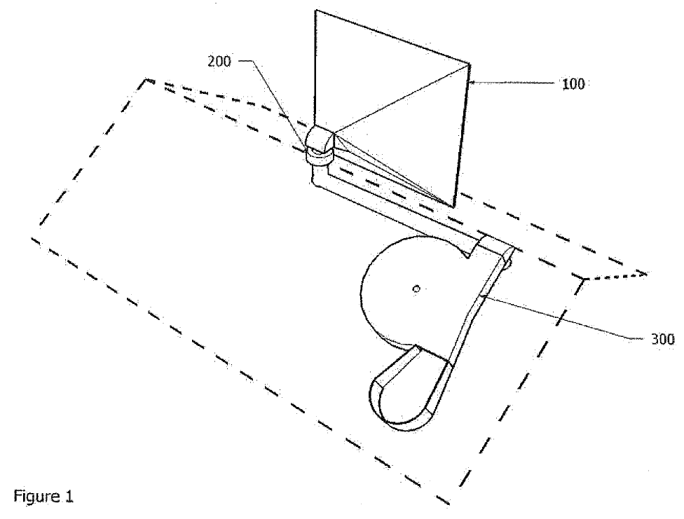

Turning now to FIG. 1, a preferred embodiment of the present invention is shown from above. The invention comprises a wind scoop 100, turret 200, and a wind turbine assembly 300. The device is shown in position on the roof of a standard suburban house.

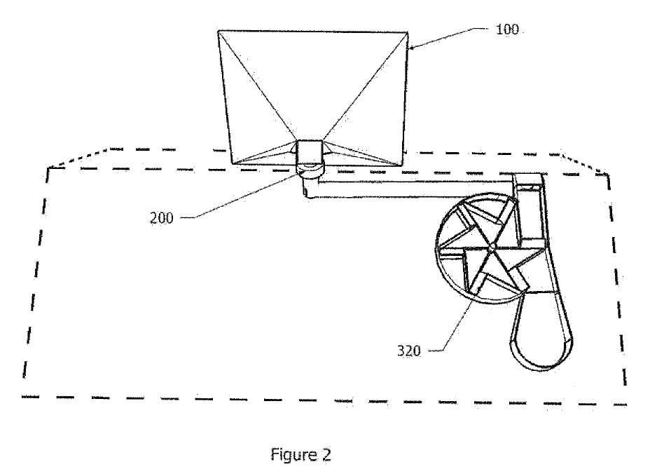

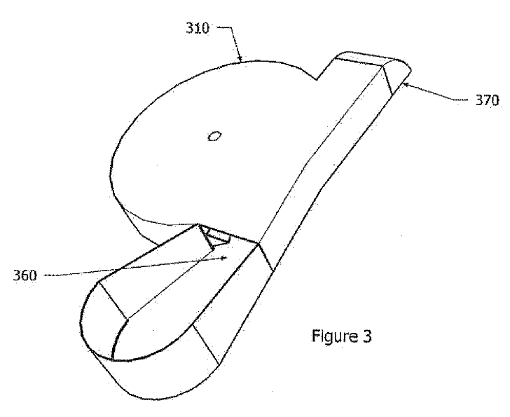

FIG. 2 shows the same preferred embodiment of the present invention, with the cover 310 removed from the turbine assembly 300. The cover 310 is displayed alone in FIG. 3. The cover has two open ends, which comprise a wind inlet scoop 360, and a wind exit aperture 370.

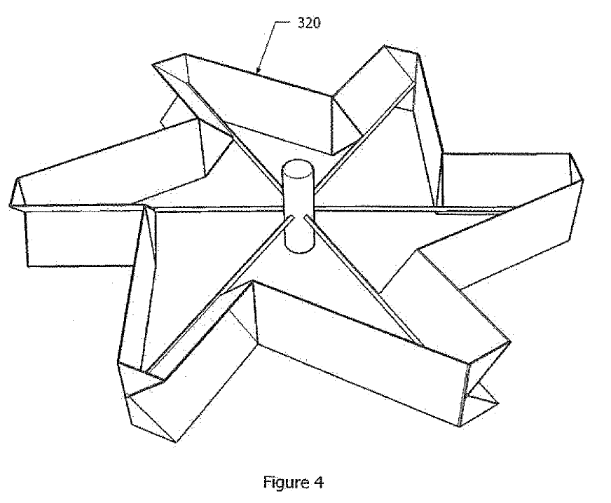

FIG. 4 illustrates the turbine blade assembly 320 from a top plan view of a preferred embodiment of the present invention. The turbine blades, propelled by wind, drive a power axle, which in this view appears in cross section as a circle in the center of the turbine blade assembly.

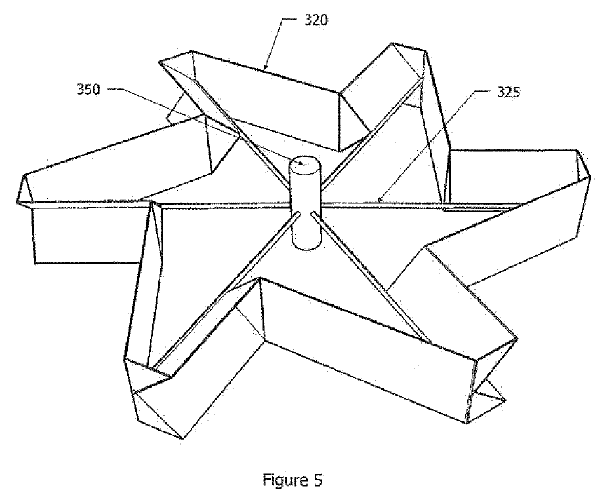

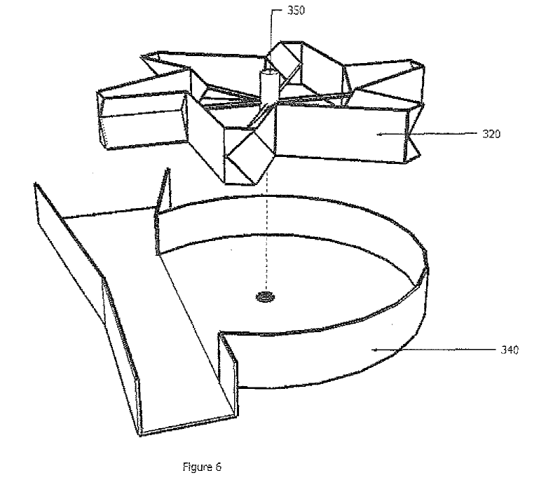

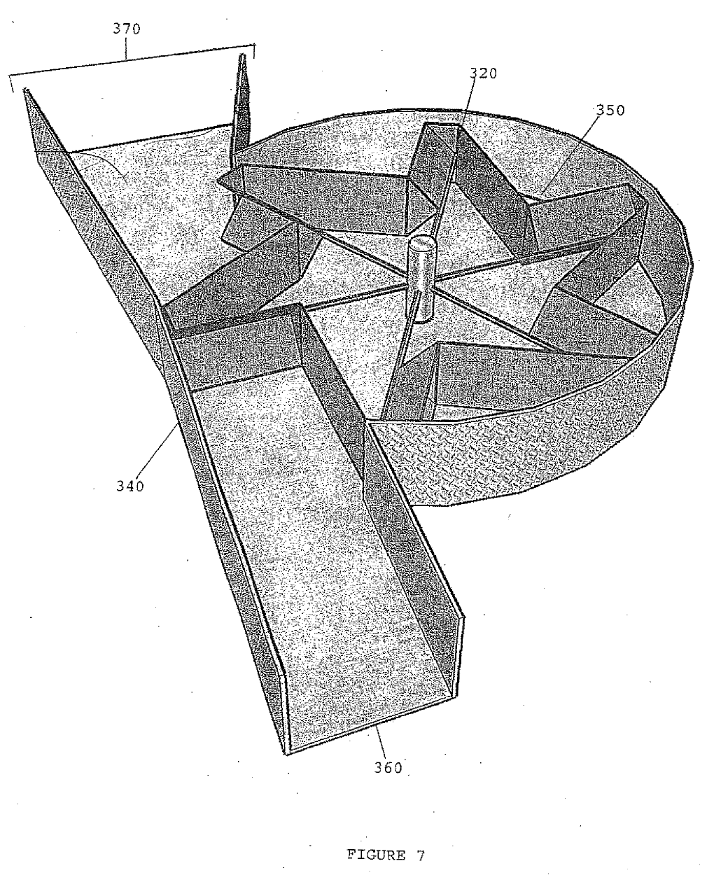

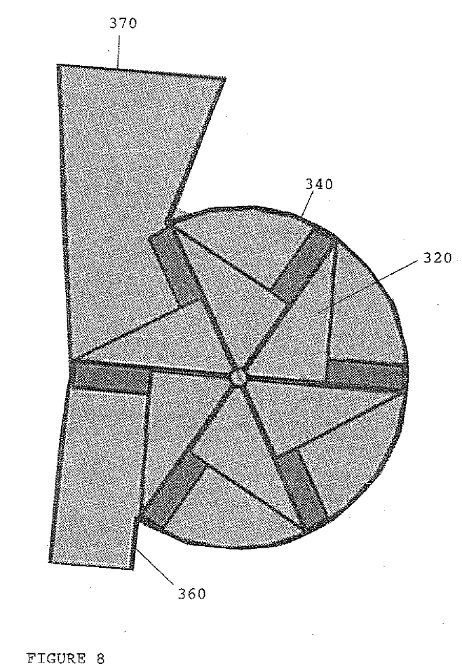

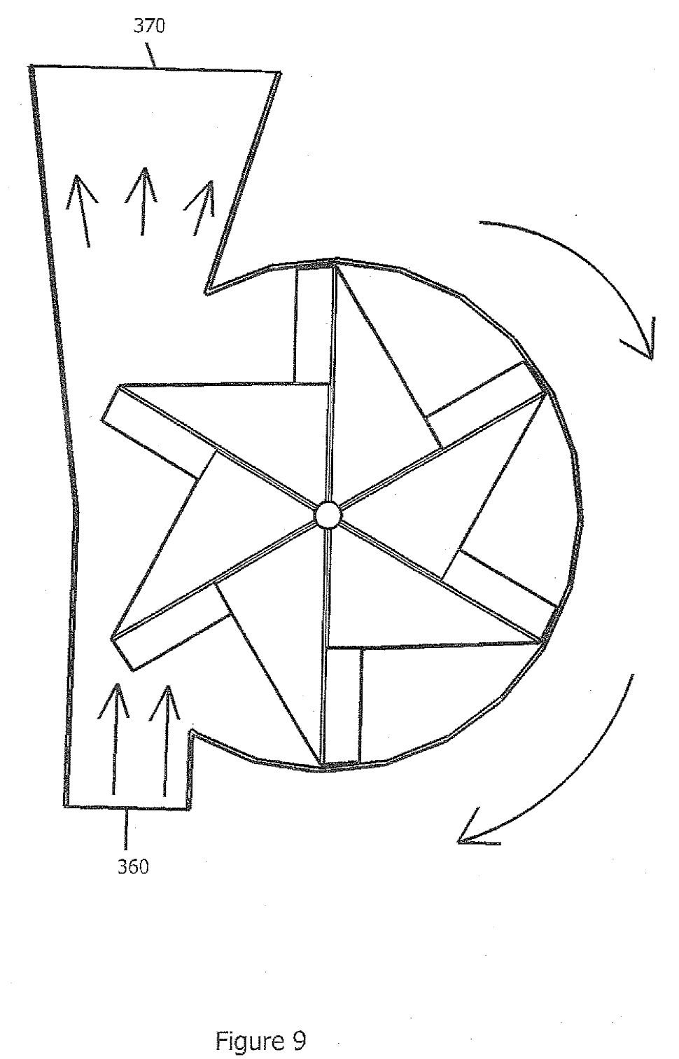

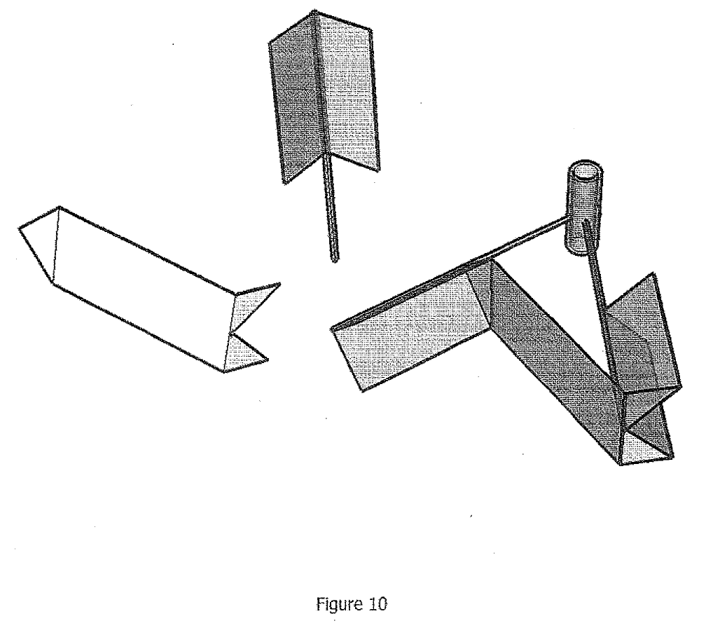

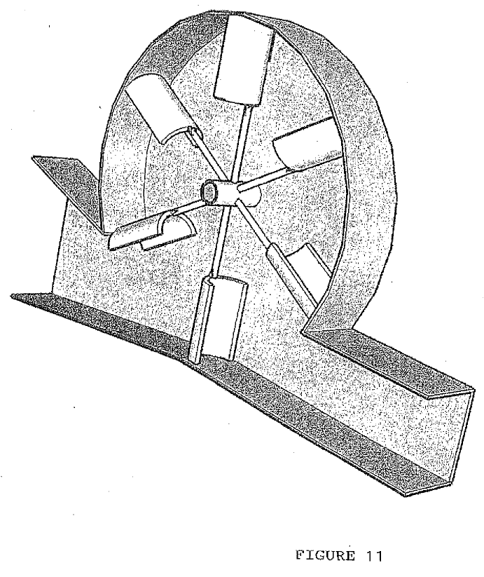

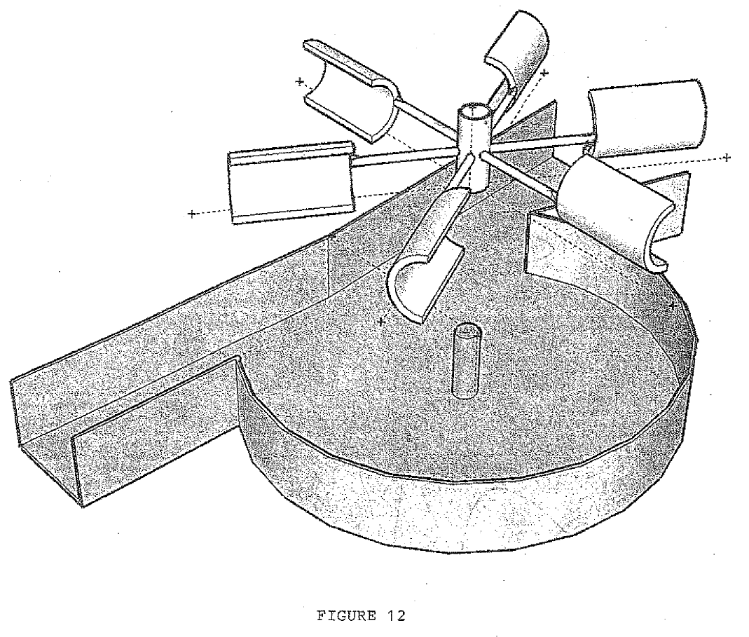

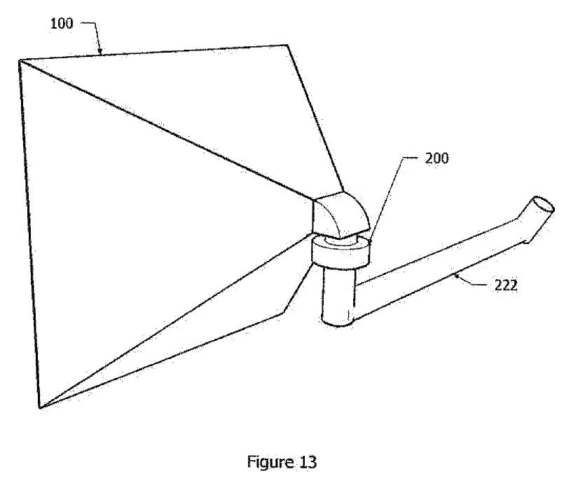

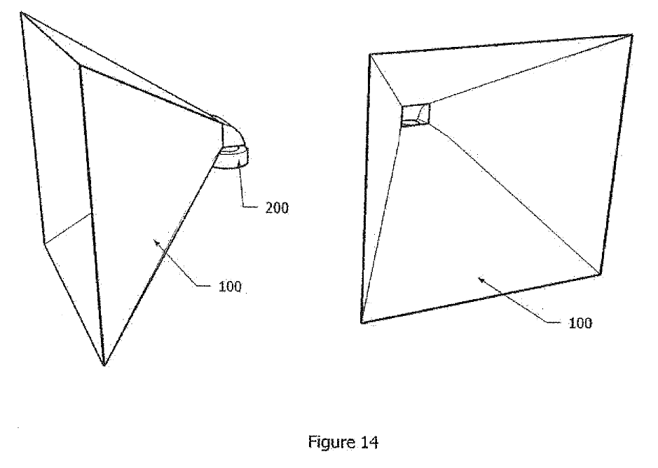

FIG. 5 displays the turbine blade assembly 320 from a perspective view. The blades in this preferred embodiment form one continuous body. The blades are connected by spokes 325 to central axle 350. When the wind turns the turbine fan, the axle 300 will also turn, transmitting energy to a conventional electrical generator.

FIG. 7 shows an exploded view of the turbine blade assembly 32 0 above its housing 340. The blade assembly fits down flush into the housing. The blades are configured to allow minimal loss of air leaking around, over, or underneath the blades. Cover 310, not shown here, fits flush on top of the housing and blade assembly.

While each component may be constructed using lightweight, thin and otherwise flexible materials, when assembled the assembly creates a structurally rigid rotor.

FIG. 7 shows an exploded interior view of wind turbine assembly 300 in a preferred embodiment of the current invention. The assembly comprises a housing 310, a turbine blade assembly 320, and a power axle 350. Turbine blade assembly 320 is designed to move in one direction only, counter-clockwise in the example shown in FIG. 7. Wind comes in via aperture 360, via conduit from the wind scoop and turntable assembly depicted in earlier figures. The wind forces the turbine blade assembly 320 to rotate around, thus in turn forcing axle 350 to move in the same direction. This moving power axle powers an electrical generator (not shown), which thus generates electricity. The air exits the wind turbine assembly to the outside atmosphere at aperture 370.

FIG. 8 shows a plan view from above of the turbine assembly with cover removed.

FIG. 9 is intended to illustrate the progression of wind through the outlet, which allows expansion of the wind stream. This configuration is expected to result in lower pressure on the backside of the rotor blade and higher pressure on the front side of the rotor blade at all positions of the rotor. Wind enters at aperture 360, circulates clockwise around housing 240 as shown via arrows, driving turbine blade assembly 320. Wind exits from the turbine at aperture 370.

FIG. 10 displays the various component elements of the turbine blade assembly 320. These are assembled into the form of the final turbine blade assembly.

It should be noted that the rotor blades could be made in a different embodiment using a different geometry, such as a curved blade rather than an angled blade. The curved blade (shown in FIGS. 11-12) is similar in shape to a pipe split in half lengthwise. These have the advantage of lightweight, modular construction. At the same time, this embodiment allows wind to leak around the blades. The preferred embodiment of FIGS. 2-10 minimizes wind leakage. Wind leakage is undesirable, as energy collection efficiency is reduced thereby.

FIG. 13 displays details of the wind collection system. For obvious reasons, wind scoop 100 must be positioned above the roof. However, the entire system is closed except at the input end of wind scoop 100, and the eventual air exit at aperture 370. Therefore, it is entirely feasible to place the entire wind turbine assembly 300 in an indoor location, for instance in the attic of a residential house, or just underneath the roof.

The scoop is maneuvered, either by remote manual or automated means, into the position that faces the wind. The scoop funnels the air into an aperture in the top 210. (Aperture 211 is obscured by the scoop 100 in the display of FIG. 13.) Air will flow from scoop 100 via pipes 222 to the wind turbine assembly.

FIG. 14 displays a view of a magnified portion of the scoop assembly of a preferred embodiment of the present invention. Displayed in FIG. 2 is a portion of the wind collection feature of the current invention, with scoop 100, and turret assembly 200. Prominent in FIG. 2 is the scoop 100, which is optionally open at its base to enable a close fit to a sloped roof.

An alternate embodiment of the current invention will encompass the capture of water energy. In this embodiment, the scoop will intake water from a supply, either natural, such as a river or stream, or an artificial source. Slight modifications to include water-tolerant materials of construction are contemplated. In general form, the scoop, turbine, and generator operate in exactly the same way as for the wind turbine. Water energy powers the turbine, thereby powering the generator to create electricity.

This alternate embodiment of the enclosed rotor concept comprises a smaller unit with round inlet and round outlet, fitted with standard plumbing couplings to be attached into the main waterline into houses and other buildings. The enclosure preferably is constructed of watertight construction, and contains either an inline turbine generator or a bladed/fenced rotor similar to the preferred wind embodiment, said rotor attached to an external generator. The turbine or generator in this alternative embodiment is matched in size and resistance to provide a similar reduction in water pressure as is achieved with water pressure regulators currently in use. Thus, this embodiment acts to draw electrical energy from current water pipe operation, without affecting the delivery or quality of the water being delivered.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. A device to aid in the harnessing of wind energy, comprising:
a wind-powered turbine;
a housing for said wind turbine;
a moveable wind scoop;
conduit means for the conducting of wind from the scoop to the turbine; and,
means for moving the scoop from one position to another.

2. The device of claim 1, wherein said means for moving the scoop comprises a turntable.

3. The device of claim 2, wherein said turntable comprises a moveable top with air inlets, and a stationary base.

4. The device of claim 1, wherein said housing comprises a semicircular track.

5. The device of claim 1, wherein said turbine blades are so disposed as to allow a minimum amount of wind to escape around the blades.

6. The device of claim 1, further comprising a generator, powered by said wind turbine.

7. The device of claim 1, wherein both scoop and turbine housing are capable of being installed on the top surface of the roof of a building.

8. A device to aid in the harnessing of wind energy, comprising:
a wind-powered turbine;
a housing for said wind turbine;
a moveable wind scoop;
conduit means for the conducting of wind from the scoop to the turbine;
a power axle driven by the notion of said turbine, and,
a turntable capable of moving the scoop from one position to another.

9. A device to aid in the harnessing water energy, comprising:
a water-powered turbine;
a housing for said water turbine;
a moveable water scoop;
conduit means for the conducting of water from the scoop to the turbine; and,
a turntable capable of moving the scoop from one position to another.
